(19) United States
(12) Patent Application Publication
(10) Pub. No.: US 2003/0062492 A1
(43) Pub. Date: Apr. 3, 2003

(54) Magnet valve with damped one-piece armature element

(75) Inventors: Rainer Haeberer, Bretten (DE); Matthias Horn, Freiberg (DE)

Correspondence Address: RONALD E. GREIGG, GREIGG & GREIGG P.L.L.C., 1423 POWHATAN STREET, UNIT ONE, ALEXANDRIA, VA, 22314, US

(73) Assignee: Robert Bosch GmbH

(21) Appl. No.: 10/183,447

(22) Filed: Jun. 28, 2002

(30) Foreign Application Priority Data
Jun. 28, 2001 (DE) 1 01 31 125.7

(51) Int. Cl. F16K 31/02

(52) U.S. Cl. 251/64; 251/129.16; 239/533.8

(57) ABSTRACT

The invention relates to a magnet valve for controlling an injection valve of a fuel injection system, having a nozzle needle/tappet assembly whose opening and closure are brought about by pressure exertion on/pressure relief of a control chamber and the magnet valve includes an electromagnet and an armature which is acted upon by a valve spring acting in the closing direction onto a valve seat which valve seat is opened or closed by a closing body that pressure-relieves the control chamber. The armature is embodied as an integral component with an armature plate and armature bolt, and an element that damps the downward motion of the armature into the valve seat is associated with the underside of the armature plate.

### BACKGROUND OF THE INVENTION

1. Field of the Invention

In internal combustion engines, injection systems with a high-pressure collection chamber (common rail) are increasingly used today. The individual fuel injectors of the engine are supplied from the common rail, which, being acted upon via a high-pressure pump, is capable of storing the fuel supply contained in it at an extremely high pressure level, virtually without pulsation. In fuel injection systems with a high-pressure collection chamber (common rail), there is a need, for reasons of emissions and noise, to be able to perform a plurality of injections in short succession. By means of injections in short succession, a preinjection phase and a main injection phase can be defined at the respective fuel injector. These phases in turn make it possible to adapt the injection quantity to the applicable phase of combustion in the combustion chamber of the engine.

2. Prior Art

In systems known from the prior art, a two-piece armature is used. The magnet armature and the magnet bolt move in common in the direction of the valve seat. Once the magnet bolt strikes the valve seat, the magnet armature plate guided at the bolt moves further in the direction of the valve seat, counter to a spring. Because only the slight mass of the bolt drops into the valve seat, the rebounding of the armature bolt, and thus wear in the valve seat, are kept slight. The armature plate moving counter to the spring strikes an overstroke stop, which absorbs its kinetic energy. After the briefest possible time, the armature plate and the bolt have resumed their position of repose, so that the next injection can take place. With this embodiment, using a two-piece armature, it is possible in principle to define minimal spacings between two successive injections.

It is moreover possible, upon closure of the fuel injector, to guide the armature plate against a resilient stop, and as a result once again the kinetic energy of the armature plate is absorbed. The armature plate and armature bolt are decoupled from one another in terms of vibration, so that the resilient stop cannot have any influence on the closing bounce of the armature bolt.

The two-piece embodiment of an armature mentioned above can be seen in more detail for instance in the magnet valve of German Patent Disclosure DE 196 50 865 A1. This proposes a magnet valve which is used to control an injection valve of a fuel injection system with a valve needle. The opening and closure of the valve needle are controlled by a magnet valve which has an electromagnet, an armature, and a valve member that is moved with the armature and is urged in the closing direction by a valve spring. The valve member cooperates with a valve seat; the armature is embodied in two parts and includes a first armature part and a second armature part. The first armature part is displaceable relative to the second armature part, counter to the force of a restoring spring, in the closing direction of the valve member under the influence of its mass inertia. A hydraulic damping device is provided on the first armature part; with this device, after-vibration of the first armature part upon its dynamic displacement can be damped. The first armature part of this embodiment is received displaceably on the second armature part, embodied as an armature bolt, and the other part of the damping device is received on a stationary part of the magnet valve.

### SUMMARY OF THE INVENTION

The embodiment proposed according to the invention offers the capability, even in one-piece armatures of a magnet valve, of reducing the variations in quantity and assuring the requisite process safety and reliability. With the proposed embodiment, the spacings between individual phases of the injection into the combustion chamber of the internal combustion engine can be reduced, since the one-piece armature is braked before or after striking the valve seat, and recoiling, that is, vibration of the one-piece armature, is quickly damped. The armature configured in one piece comes to rest faster, so that short injection spacings are possible. On the one hand, recoiling of the armature in its guide in the injector housing below the magnet coil and above the outlet throttle that pressure-relieves the control chamber can be avoided; on the other, damping of the stop motion brings about a reduction in wear at the valve seat. The braking of the one-piece armature immediately before the armature strikes the valve seat (first closing bounce) reduces the mechanical stress on the valve seat and on the striking face of the armature. To that end, a progressive-action spring can be disposed between the armature plate and the armature guide sleeve, which brakes the kinetic energy of the armature briefly before reaching impact—because of the progressively increasing retention force of the spring—and converts its kinetic energy into shape-changing energy. In addition to the use of a progressive spring element that engages the one-piece armature from below, an elastic element, such as a spiral spring, can be received below the armature plate of the one-piece armature. This spiral spring is disposed below the armature plate of the one-piece armature in an extended or in other words relaxed length, and upon contact with the armature plate of the one-piece armature, it acts thereon as a delay element. The kinetic energy of the one-piece armature is reduced by the damping element embodied as a spiral spring.

Finally, it is possible, under the armature plate of the one-piece armature, to dispose an element of a nonmagnetic material, braced by a spring element. When of the one-piece armature, that is, its armature plate, strikes the resiliently supported element, the one-piece armature likewise undergoes a deceleration. The impact of the one-piece armature on the valve seat in the injector body above the outlet throttle of the control chamber can also be damped by providing plane faces, between the armature plate and the guide of the one-piece armature, that move toward one another in the downward motion of the armature and that act as a hydraulic spring/damping element. The hydraulic spring/damping element can also be embodied as a labyrinth element, so that by suitable shaping, a damping characteristic can be established.

In a further possible embodiment of the present invention, a coupling oscillator can be disposed below the armature plate of the one-piece armature; the coupling oscillator has both a magnetic plate or a disk and a spring that supports that element. When the one-piece armature is opened, the magnetic flux causes the plate mass to be attracted together with the one-piece armature. In this state, the plate presses against the armature. Upon closure, current is withdrawn from the magnet; the spring acting on the one-piece armature presses the one-piece armature, together with the supplementary mass, against the supplementary-mass spring that supports it, in the direction of the valve seat. When the armature strikes the valve seat, the supplementary mass, configured in disklike fashion, separates from the underside of the armature plate and, because of its inertia, moves back in the direction of the valve seat. In this variant embodiment, an adaptation of the supplementary mass and the supplementary-mass spring is necessary, such that the supplementary mass strikes the armature before the second impact of the armature in the valve seat and is thus capable of reducing the kinetic energy of the armature.

### BRIEF DESCRIPTION OF THE DRAWINGS

Various embodiments of the present invention will now be described in further detail herein below, in conjunction with the drawings, in which:

FIG. 1, a two-piece armature, including a magnet armature plate and a magnet bolt, that is known from the prior art;

FIG. 2, an armature, embodied in one piece, of a magnet valve, which armature actuates an outlet throttle of a control chamber;

FIG. 3, an armature configured in one piece and acted upon in its impact motion by a progressive damping element;

FIG. 4, is a graph showing the actuation bounces that ensue upon actuation of the armature, and the sequence from the first closing bounce and the second closing bounce following it, plotted on the time axis;

FIG. 5, an elastic element, embodied as a spiral spring, disposed below the armature plate of the one-piece armature;

FIG. 6, an one-piece armature, damped by a nonmagnetic, resiliently supported mass;

FIG. 7, a one-piece armature, whose downward motion is decelerated by a hydraulically acting spring/damping element;

FIG. 8, one embodiment of the hydraulically acting spring/damping element of FIG. 7 with labyrinth shaping; and

FIG. 9, a coupling oscillator disposed below the armature plate of the one-piece armature.

### DESCRIPTION OF THE PREFERRED EMBODIMENTS

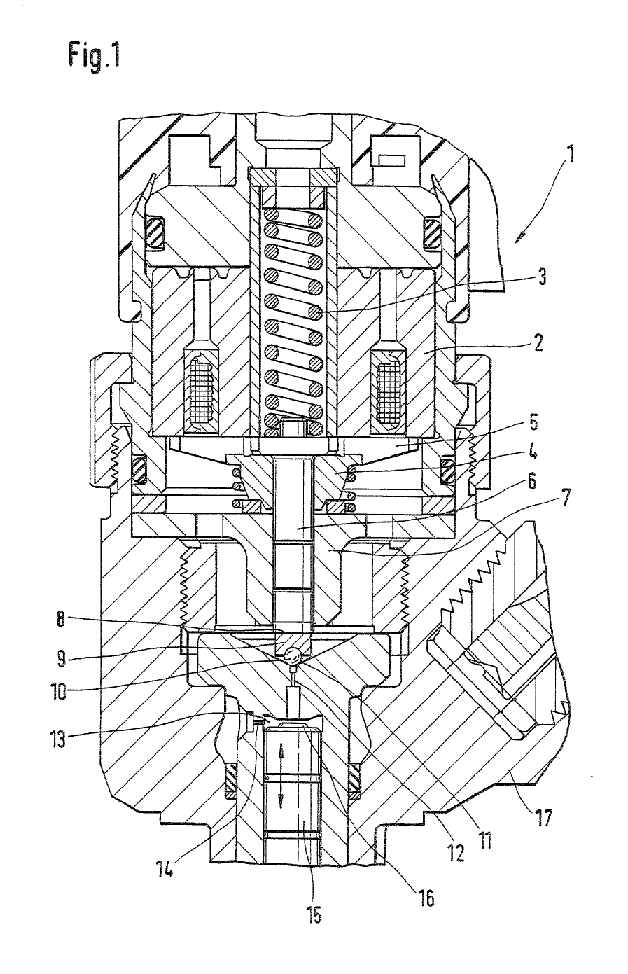

From FIG. 1, a magnet valve with a known armature embodied in two parts can be seen.

The magnet valve 1 includes an electromagnet 2, which is penetrated by a valve spring 3 which is surrounded in turn by a sleeve. The two-piece armature surrounds an armature plate 5, which is supported on a slide sleeve 4 that in turn is penetrated by the armature bolt 6 of the two-part armature. The slide sleeve is prestressed via a spiral spring element against the valve spring 3, so that the valve spring 3 is kept in contact with the top side of the armature plate 5. The armature bolt 6 is surrounded by a bolt guide 7. The armature bolt 6, on its lower end, surrounds an end face 8, on which a shaped element 9 is received. The shaped element 9 is adapted to the shape of the closing body 10 shown here. This closing body 10 closes a valve seat 11, below which an outlet throttle 12 discharges. The outlet throttle 12 is associated with a control chamber 13 in the injector body 17 of the fuel injector, in the view of FIG. 1.

Via the closing body 10, actuatable by means of the magnet valve 1 and located above the outlet throttle 12, a pressure relief of the control chamber 13 can be brought about. The exertion of pressure on the control chamber 13 in the interior of the injector body 17 is effected by means of an inlet throttle element 14, which discharges laterally in a boundary wall of the control chamber 13. The control chamber 13 is defined not only by the boundary wall of the injector body 17 but also by a face end 16 of a nozzle needle/tappet assembly 15. Depending on whether pressure is exerted on the control chamber 13 or pressure is relieved, via the inlet throttle 14 or the outlet throttle 12, the latter being closable and openable by the magnet valve 1, respectively, a closing motion of the nozzle needle/tappet assembly 15 in the injector body 17 can be effected, in which the injection openings, not shown here and discharging into the combustion chamber of the engine, are closed. Conversely, if by actuation of the magnet valve 1 a pressure relief of the control chamber 13 is effected by means of the control chamber volume flowing out via the outlet throttle 12, then the injection openings, not shown here and discharging into the combustion chamber of the engine, on the lower end of the nozzle needle/tappet assembly 15 are uncovered, and an injection of fuel into the combustion chamber ensues.

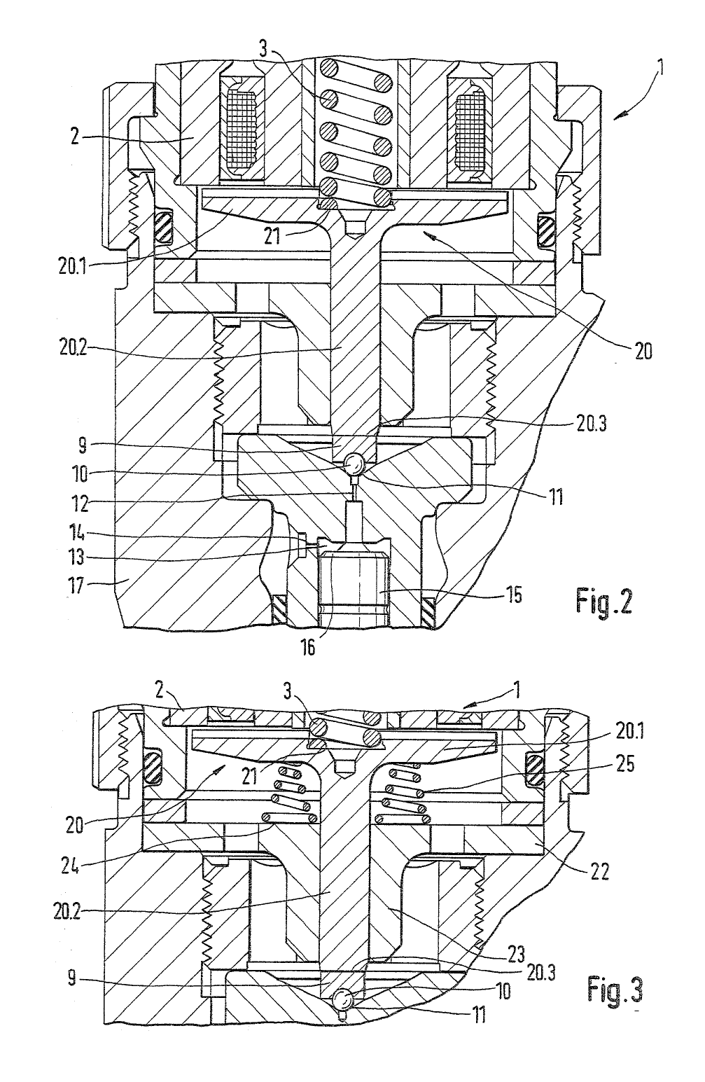

The illustration in FIG. 2 shows the layout of an one-piece armature that is actuatable by means of an electromagnet.

Analogously to the illustration of FIG. 1, the magnet valve 1 includes an electromagnet 2, which is penetrated by a valve spring 3 which in turn is surrounded by a sleevelike component. In a distinction from the embodiment of the armature known from the prior art in the form of a two-piece component comprising an armature plate 5 with a slide sleeve 4 embodied on it and with an armature bolt 6 movable relative to the armature plate, the armature 20 shown in FIG. 2, associated with the magnet valve 1 and actuatable via the electromagnet 2, is embodied as a one-piece component.

The armature 20 embodied as a one-piece component includes an armature plate 20.1 and an armature bolt 20.2, whose end face is identified by reference numeral 20.3. Received on the end face 20.3 of the one-piece armature 20 is the shaped element 9, complementary to the shape of the closing body 10. The one-piece armature 20 also includes a recess 21, on which the valve spring 3 is braced, by which spring the one-piece armature 20 in the injector body housing 17 is urged downward onto the valve seat 11.

Analogously to what FIG. 1 shows, a control chamber 13 is embodied in the interior of the injector body 17; it can be subjected to a control volume via the inlet throttle 14, and upon opening of the closing body 10 it can be pressure-relieved out of its seat 11 by means of control chamber volume flowing out via the outlet throttle 12. This imposes a reciprocating motion on the nozzle needle/tappet assembly 15 in the injector body 17, and this motion is used for either opening or closing injection openings, not shown here, into the combustion chamber of the engine.

FIG. 3 shows a first variant of the embodiment according to the invention, with an armature plate, supported by a damping element, of an one-piece armature.

The armature 20 embodied as a one-piece component includes an armature plate 20.1, which changes over into an armature bolt 20.2. Embodied on the underside of the armature bolt 20.2 is an end face 20.3, which serves to receive the shaped element 9. The shaped element 9 in turn acts on a closing body 10, which when the magnet valve 1 is switched off is pressed by the action of the valve spring 3 into the valve seat 11, above an outlet throttle not shown here, and thus keeps the control chamber 13 closed.

The armature bolt 20.2 is in turn surrounded by a disklike support element 22, which includes a guide portion 23 for guiding the armature bolt 20.2 of the one-piece armature 20. The top side of the support element 22 acts as a support face 24 for a damping element 25, embodied as a progressive-action spring element. This element is located between the underside of the armature plate 20.1 and the support face 24 of the support element 22. The progressive-action damping element 25 brakes the one-piece armature 20 shortly before the latter reaches the valve seat 11, so that its impact impulse on the valve seat 11 is reduced, and the kinetic energy of the one-piece armature 20 is converted into shape-changing energy of the progressive-action damping element 25. Reducing the impact impulse of the one-piece armature 20 at the valve seat 11 achieves a reduced armature rebound after the closing event, which prevents a buildup of vibration in the one-piece armature 20 in the injector body 17.

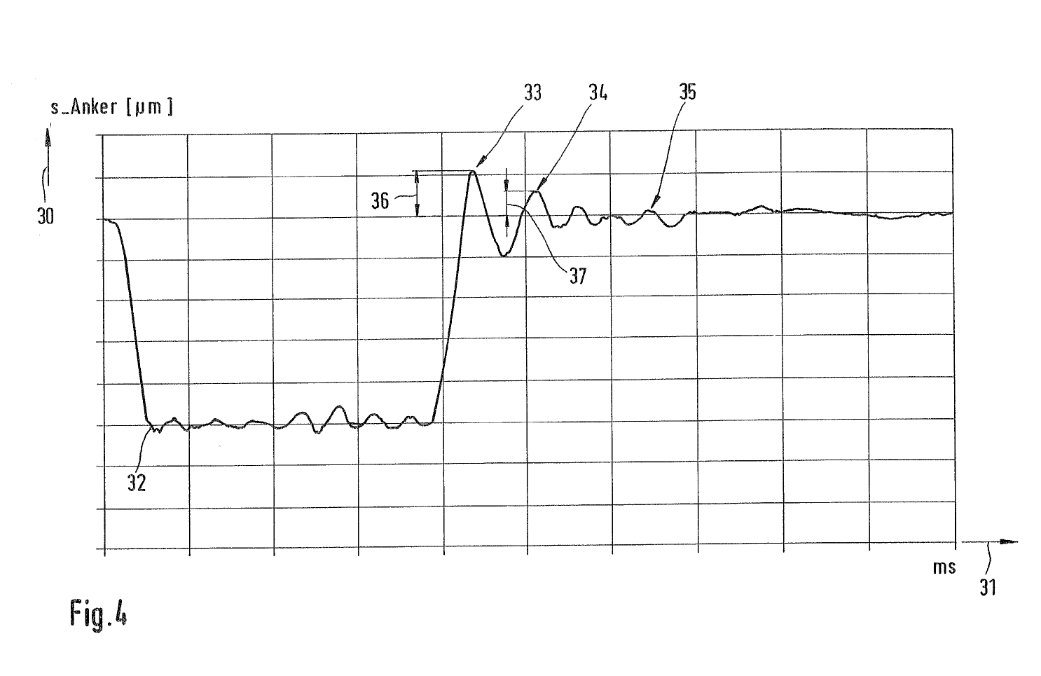

FIG. 4 shows as an example the course of an armature motion in the injector housing 2 after activation, and the closing bounces occurring upon its triggering, in chronological succession.

The armature travel 30 is plotted in micrometers over the time axis 31. Reference numeral 32 marks the amplitude of the bounce 32 upon activation. When the electromagnet 2 of the magnet valve 1 is activated, the armature plate 20.1 of the one-piece armature 20 is actuated counter to the action of the valve spring 3; accordingly, an opening of the closing body 10 and an uncovering of the outlet throttle 12, or in other words a pressure relief of the control chamber 13, ensue.

If the current supply to the electromagnet 2 of the magnet valve 1 is switched off, a downward motion, caused by the action of the valve spring 3, of the one-piece armature 20 occurs in the direction of the valve seat 11 of the closing body 10. At reference numeral 33, the so-called first closing bounce appears, which is characterized by an amplitude 36. The amplitude 36 designates the amount by which the armature overswings, relative to a maximally faded vibration that is marked by reference numeral 35 in FIG. 4. After the first closing bounce 33, the armature executes a further closing bounce 34, that is, the second closing bounce. The second closing bounce 34 differs from the first closing bounce 33 in having a lesser maximal amplitude 37 with respect to a maximally faded vibration, which is identified in the view of FIG. 4 by reference numeral 35.

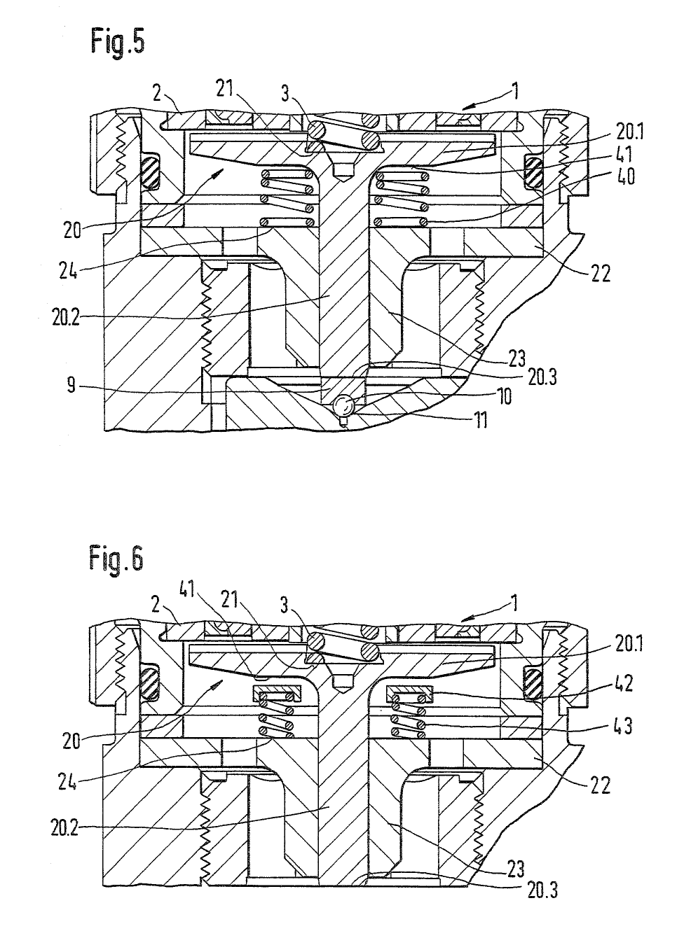

A further variant of the embodiment proposed according to the invention is shown in FIG. 5.

In this variant embodiment, one or more elastic elements, such as spiral springs or springs 40 configured in some other way, are provided between the underside 41 of the armature plate 20.1 and the support face 24 of the support element 22. These damping elements are received in the free space between the top side 24 of the support element 22 and the underside 41 of the armature plate 20.1. They are not prestressed; that is, they are in their lengthened-out or relaxed position. Not until the current supply to the electromagnet 2 is cancelled does the one-piece armature 20, moved in the direction of the valve seat 11, with its underside 41 touch the damping elements 40, so that not until shortly before reaching the closing direction is a deceleration pulse exerted by the damping element or elements 40 on the armature 20. By the deceleration impulse, the kinetic energy intrinsic to the moving armature 20 is converted into shape-changing energy of the damping element or elements 40.

The view in FIG. 6 shows a further variant of the embodiment proposed according to the invention, in which nonmagnetic masses 42 are disposed below the armature plate of an one-piece armature and are thus braced.

In this variant embodiment, masses 42, which comprise a nonmagnetizable material and are received on one or more spring elements 43, are located between the support face 24 of the support element 22 and the underside 41 of the armature plate 20.1 of the one-piece armature 20. When the armature 20 is put by magnetization of the electromagnet 2 into its open position, that is, an enabling position of the valve seat 11, a gap exists between the underside 41 of the armature plate 20.1 and the top side of the masses 42 of nonmagnetizable material. When the electromagnet 2 of the magnet valve 1 is switched off, a deceleration is impressed upon the armature plate 20.1, and thus on the one-piece armature 20, upon contact with the masses 42 of nonmagnetizable material. Since the armature 20 is embodied as a one-piece component, braking the motion of the armature plate 20.1 also impresses a deceleration on the armature bolt 20.2, so that by means of a deceleration of the motion of the armature plate 20.1 in the injector body, a deceleration of the armature bolt 20.2 is attainable as well, which latter now strikes the valve seat 11 with a reduced impact speed and a reduced impact impulse. As a result, the service life is increased and the mechanical stress on the valve seat as well as on the components 20.2, 20.3, 9, 10 and 11 that enter into contact with one another are reduced considerably.

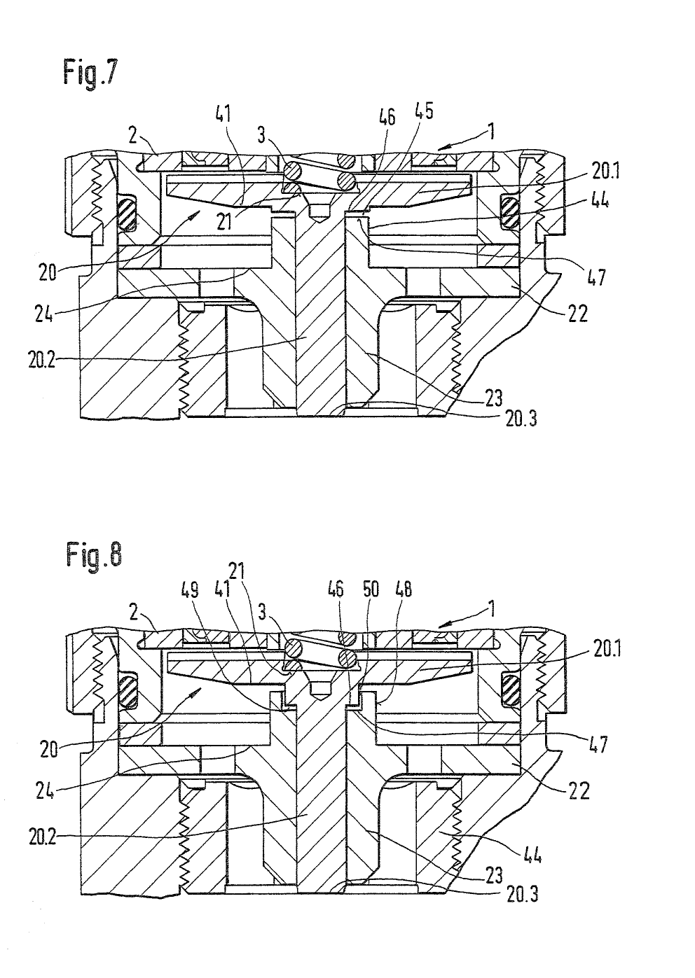

From FIG. 7, a variant of the embodiment of the invention can be seen in which the damping element below the armature plate of an one-piece armature is embodied as a hydraulic spring/damping element.

In this variant embodiment, in the region of the underside 41 of the armature plate 20.1, an extension of the armature plate 20.1 is formed on which a first, annularly extending plane face 46 is embodied. Opposite this face on the collar of the support element 22, which merges with a guide portion 23, is a second plane face 47. The first plane face 46 on the armature plate 20.1 and the second plane face 47 on the collar of the support element 22 form a gap 45, which when the first plane face 46 and the second plane face 47 are moved toward one another functions as a hydraulic damping element, by enclosing a damping medium, such as excess fuel.

FIG. 8 shows a further variant embodiment of a hydraulically functioning spring/damping element below the armature plate of an one-piece armature.

In this variant embodiment, once again an extension, which includes a first plane face 46, is embodied on the underside 41 of the armature plate 20.1. Unlike the variant embodiment of a hydraulic spring/damping element as shown in FIG. 7, a labyrinth gap 48 on the collar of the support element 22 is formed here, on the one hand by the gap size 49 between the first plane face 46 on the armature plate 20.1 of the one-piece armature 20 and the second plane face 47 in the bottom of the collar of the support element 22. Another part of the labyrinth gap 48 is defined by the diameter difference of an inner bore in the collar region of the support element 22 and by the outer diameter of the extension on the underside 41 of the armature plate 20.1 of the one-piece armature 20. By enclosing a fuel volume, for instance between the first plane face 46 and the second plane face 47, a fluid cushion is formed there, which when the extension on the underside 41 of the armature plate 20.1 moves into the correspondingly configured collar of the support element 22 impresses a damped braking on the armature. In this variant, the desired spring or damping characteristic is adjustable via the geometric shaping of the labyrinth 48.

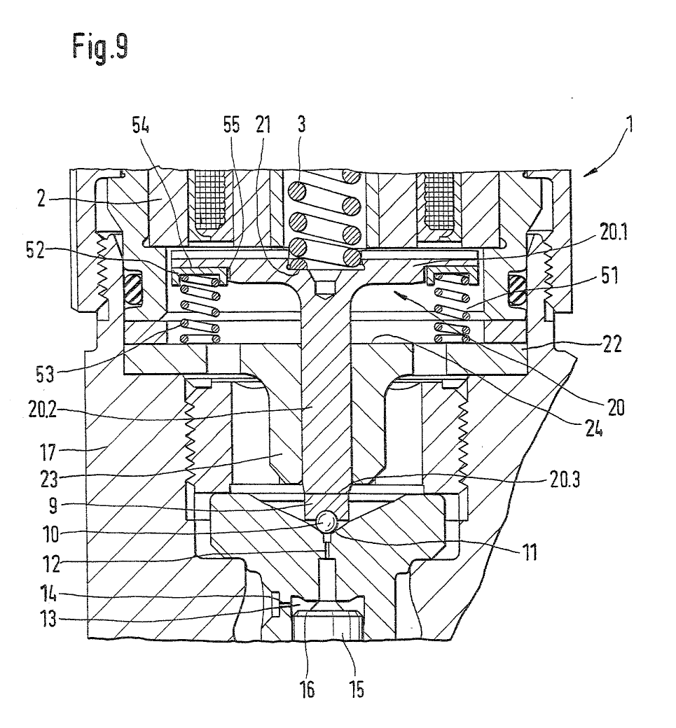

From FIG. 9, another variant of the embodiment of the invention can be seen, in which a coupling oscillator is disposed below the armature plate of the one-piece armature.

In this variant embodiment of the concept on which the invention is based as well, an one-piece armature 20, which is actuated by the electromagnet 2 of the magnet valve 1, includes an armature plate 20.1, which changes over into an armature bolt 20.2 with an end face 20.3 embodied on it. The armature bolt 20.2 is guided in the injector body 17 in a guide portion 23 of the support element 22. The top side of this support element functions as a support face 24 for a coupling oscillator 51, which includes a supplementary mass 52 that here is configured annularly. The annular supplementary mass 52 is braced by at least one supplementary-mass spring 53. The supplementary-mass springs 53, of which two or more can be received, distributed in a star pattern or otherwise opposite one another on the support face 24 of the support element 22, are preferably embodied as spiral springs. The supplementary mass 52, which in the variant embodiment shown in FIG. 9 is designed for instance as extending annularly, preferably includes a magnetic material. When the closing body 10 opens because current is supplied to the electromagnet 2 of the magnet valve 1, the magnetic flux causes the supplementary mass 52, together with the one-piece armature 20, to be attracted against the underside of the electromagnet 2. In this state, the supplementary-mass springs 53, which brace the supplementary masses 52 and are embodied here as spiral springs, push the supplementary mass 52 against the underside 41 of the armature plate 20.1. To that end, a contact ring 54 can be embodied on the underside of the armature plate 20.1 of the one-piece armature; this contact ring is defined by an inner shoulder 55, so that a defined contact of the supplementary mass 52 with the underside of the armature plate 20.1 is assured.

Upon closure of the magnet valve 1, its electromagnet 2 no longer receives current, so that the one-piece armature is moved toward the valve seat 11 by the action of the valve spring 3. The valve spring 3 is braced on a recess 21 on the top side of the armature plate 20.1 of the one-piece armature 20, counter to the action of the supplementary mass 52, which is exerted by the one or more supplementary-mass springs 53 against the underside 41 of the armature plate 20.1. When the armature 20 strikes, that is, when the shaped body 9 received on its face end 20.3 strikes the closing body 10 above the valve seat 11, the supplementary mass 52, because of its inertia, moves onward in the direction of the valve seat 11 while the armature plate 20.1, and thus the armature bolt 20.2, has already reached this valve seat. This defines the first closing bounce 33. The supplementary mass 52 and the rigidity of the supplementary-mass springs 53 that brace the supplementary mass 52, it being noted that there can be one or more supplementary-mass springs, must be adapted to one another in such a way that the supplementary mass 52, before the second impact (second closing bounce 34) of the one-piece armature 20 in the valve seat 11, rests once again on the underside, that is, the contact ring 54 of the armature plate 20.1, and thus reduces the kinetic energy that is still intrinsic to the armature 20 and that would otherwise cause a vibration.

With the variant embodiments, shown in FIGS. 3-9, of damping elements that are received below an armature plate 20.1 of an armature 20 configured in one piece, the one-piece armature 20 can be braked immediately before or after its impact on the valve seat 11, and the recoil of the one-piece armature 20 can thus be maximally avoided. The one-piece armature 20 comes to rest faster, by means of the variant embodiments proposed according to the invention, so that smaller injection spaces in a nozzle needle/tappet assembly 15 can be achieved. The damping of the striking motion of the armature 20 upon impact has a favorable effect on the wear to which the valve seat 11, closable by the closing body 10, is subjected.

The foregoing relates to preferred exemplary embodiments of the invention, it being understood that other variants and embodiments thereof are possible within the spirit and scope of the invention, the latter being defined by the appended claims.

We claim:

1. A magnet valve for controlling an injection valve of a fuel injection system, having a nozzle needle/tappet assembly (15), whose opening and closure are brought about by pressure exertion on/pressure relief of a control chamber (13), and the magnet valve includes an electromagnet (2) and an armature (20), which armature is acted upon by a valve spring (3), acting in the closing direction onto a valve seat (11), which valve seat is opened or closed by a closing body (10) that pressure-relieves the control chamber (13),
the armature (20) being embodied as an integral component with an armature plate (20.1) and armature bolt (20.2), and
an element (25, 40; 42, 43; 46, 47; 48; 51) that damps the downward motion of the armature (20) into the valve seat (11) associated with an underside (41) of the armature plate (20.1).

2. The magnet valve of claim 1 wherein the one-piece armature (20) is guided in a support element (22), whose top side functions as a support face (24) for the damping element (25; 40; 42, 43; 51).

3. The magnet valve of claim 2 wherein the support element (22) includes a sleevelike guide portion (23), in which the armature bolt (20.2) of the one-piece armature (20) is guided.

4. The magnet valve of claim 2 further comprising a second plane face (47) on the collar of the support element (22) opposite the underside (41) of the armature plate (20.1).

5. The magnet valve of claim 2 further comprising a labyrinth gap 48 defined by a contour disposed on the collar of the support element (22) cooperating with an extension on the underside (41) of the armature plate (20.1).

6. The magnet valve of claim 1 further comprising a damping element (25) received between the underside (41) of the armature plate (20.1) and a support element (22), the damping element acting in accordance with a progressively extending characteristic curve.

7. The magnet valve of claim 1 further comprising at least one damping element (42), which is braced by a spring (43) that is braced on a support face (24) of the support element (22) and is associated with the underside (41) of the armature plate (20.1).

8. The magnet valve of claim 7 wherein the damping element (42) comprises nonmagnetizable material.

9. The magnet valve of claim 7 wherein the diameters of the damping element (42) and of the underside (41), acting as a stop, of the armature plate (20.1) of the one-piece armature (20) agree with one another.

10. The magnet valve of claim 1 further comprising a second plane face (47) on the collar of the support element (22) opposite the underside (41) of the armature plate (20.1), wherein the damping element (46, 47) functions hydraulically, the damping element having a gap (45) defined by a first plane face (46) of the armature plate (20.1) and the second plane face (47) on the collar of the support element (22).

11. The magnet valve of claim 1 further comprising a labyrinth gap 48 defined by a contour disposed on the collar of the support element (22), cooperating with an extension on the underside (41) of the armature plate (20.1), wherein the damping element (46, 47) functions hydraulically and includes a labyrinth gap (48) defined by the diameter difference (50) between the extension on the underside (41) of the armature plate (20.1) and the inside diameter of the collar of the support element (22) and by the gap size (49).

12. The magnet valve of claim 1 wherein the damping element (51) is embodied as a coupling oscillator and includes at least one supplementary mass (52) disposed on at least one supplementary-mass spring (53).

13. The magnet valve of claim 12 wherein the supplementary mass (52) is embodied annularly and rests on a contact (54) on the underside (51) of the armature plate (20.1) of the armature (20).

14. The magnet valve of claim 12 wherein the coupling oscillator (51) includes a plurality of supplementary masses (52), which are each braced by supplementary-mass springs (53).

15. The magnet valve of claim 12 wherein the at least one supplementary mass (52) and the supplementary mass springs (53) are adapted in such a way that the at least one supplementary mass (52) brake the armature (20) before the second closing bounce (34) of the armature (20) in the valve seat (11).
